(19) United States
(12) Patent Application Publication
(10) Pub. No.: US 2009/0262554 A1
(43) Pub. Date: Oct. 22, 2009

(54) DISPLAY APPARATUS

(75) Inventors: Soo-Hyun LEE, Gwangju-si (KR); Jo-Yeon JO, Asan-si (KR); Ju-Yong SHIN, Seoul (KR)

Correspondence Address: Haynes and Boone, LLP;IP Section, 2323 Victory Avenue, SUITE 700, Dallas, TX, 75219, US

(73) Assignee: Samsung Electronics Co., Ltd.

(21) Appl. No.: 12/425,281

(22) Filed: Apr. 16, 2009

(30) Foreign Application Priority Data
Apr. 17, 2008 (KR) 10-2008-0035656

(51) Int. Cl. F21V 7/04

(52) U.S. Cl. 362/633

(57) ABSTRACT

Provided is a display apparatus including an intermediate frame and a lower container which can be easily joined to or disjoined from each other without being deformed. The display apparatus includes: a display panel which displays images; an intermediate frame on which the display panel is placed and which is split into two or more frames; and a container which is split into two or more containers, is coupled to the intermediate frame, and includes a light source cover integrally formed on at least a side thereof, wherein a light source is inserted into the light source cover.

This application claims priority from Korean Patent Application No. 10-2008-0035656 filed on Apr. 17, 2008 in the Korean Intellectual Property Office, the disclosure of which is incorporated herein by reference in its entirety.

### BACKGROUND OF THE INVENTION

1. Field of the Invention

The present invention relates to a display apparatus, and more particularly, to a display apparatus including an intermediate frame and a lower container which can be easily joined to or disjoined from each other without being deformed.

2. Description of the Related Art

As modern society becomes more dependent on sophisticated information and communication technologies, the market needs for larger and thinner displays are growing. In particular, since conventional cathode ray tubes (CRTs) have failed to fully satisfy these market needs, the demand for flat panel displays (FPDs), such as plasma display panels (PDPs), plasma address liquid crystal display panels (PALCs), liquid crystal displays (LCDs), and organic light emitting diodes (OLEDs), is exploding.

Being low in power-consumption, light and compact, FPDs are widely applied in computer, electronics, and information technology (IT) industries. A conventional FPD includes a liquid crystal panel assembly having a liquid crystal panel which displays image information, a backlight assembly having lamps which emit light and a light guide plate (LGP) which guides light emitted from the lamps toward the liquid crystal panel, and a container receiving the liquid crystal panel assembly and the backlight assembly therein.

As the design of FPDs becomes optimized, the sizes of an intermediate frame and a container included in a FPD are gradually being reduced. However, as the intermediate frame and the container become slimmer, they are often broken or deformed when they are disjoined from each other, thereby reducing productivity.

### SUMMARY OF THE INVENTION

Aspects of the present invention provide a display apparatus including an intermediate frame and a lower container which can be easily joined to or disjoined from each other without being deformed.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a display apparatus including: a display panel which displays images; an intermediate frame on which the display panel is placed and which is split into two or more frames; and a container which is split into two or more containers, is coupled to the intermediate frame, and includes a light source cover integrally formed on at least a side thereof, wherein a light source is inserted into the light source cover.

According to another aspect of the present invention, there is provided a display apparatus including: a display panel which displays images; a first frame which includes first sidewalls, first flanges protruding respectively from the first sidewalls toward the center of the first frame and having the display panel placed thereon, and first extension portions extending from respective top ends of the first sidewalls; a second frame which includes second sidewalls, second flanges and second extension portions coupled to the first sidewalls, the first flanges and the first extension portions, respectively, and which is coupled to the first frame; and a container which is split into two or more containers and coupled to the first and second frames.

### BRIEF DESCRIPTION OF THE DRAWINGS

The above and other aspects and features of the present invention will become more apparent by describing in detail exemplary embodiments thereof with reference to the attached drawings, in which:

FIG. 1 is a perspective view of a display apparatus according to a first exemplary embodiment of the present invention;

FIG. 2 is an exploded perspective view of the display apparatus of FIG. 1;

FIG. 3 is a cross-sectional view of the display apparatus taken along a line III-III′ of FIG. 1;

FIG. 4 is a cross-sectional view of the display apparatus taken along a line VI-VI′ of FIG. 1;

FIG. 5 is a partial exploded perspective view of an intermediate frame and a lower container included in the display apparatus of FIG. 1;

FIG. 6 is a perspective view of the intermediate frame and the lower container of FIG. 5 which are coupled to each other;

FIG. 7A is a partial plan view of the intermediate frame included in the display apparatus of FIG. 1;

FIG. 7B is a partial plan view illustrating a modified version of the intermediate frame of FIG. 7A;

FIG. 7C is a partial plan view illustrating another modified version of the intermediate frame of FIG. 7A;

FIG. 8 is a partial exploded perspective view of an intermediate frame included in a display apparatus according to a second exemplary embodiment of the present invention;

FIG. 9 is a perspective view of the intermediate frame of FIG. 8 which has first and second frames coupled to each other;

FIG. 10 is a partial exploded perspective view of an intermediate frame included in a display apparatus according to a third exemplary embodiment of the present invention;

FIG. 11 is a perspective view of the intermediate frame of FIG. 10 which has first and second frames coupled to each other;

FIG. 12 is a partial exploded perspective view of an intermediate frame included in a display apparatus according to a fourth exemplary embodiment of the present invention; and

FIG. 13 is a perspective view of the intermediate frame of FIG. 12 which has first and second frames coupled to each other.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments as set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

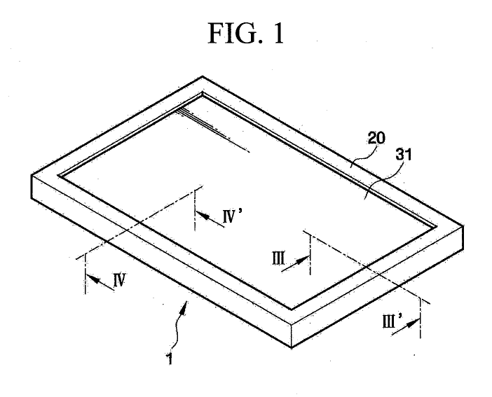

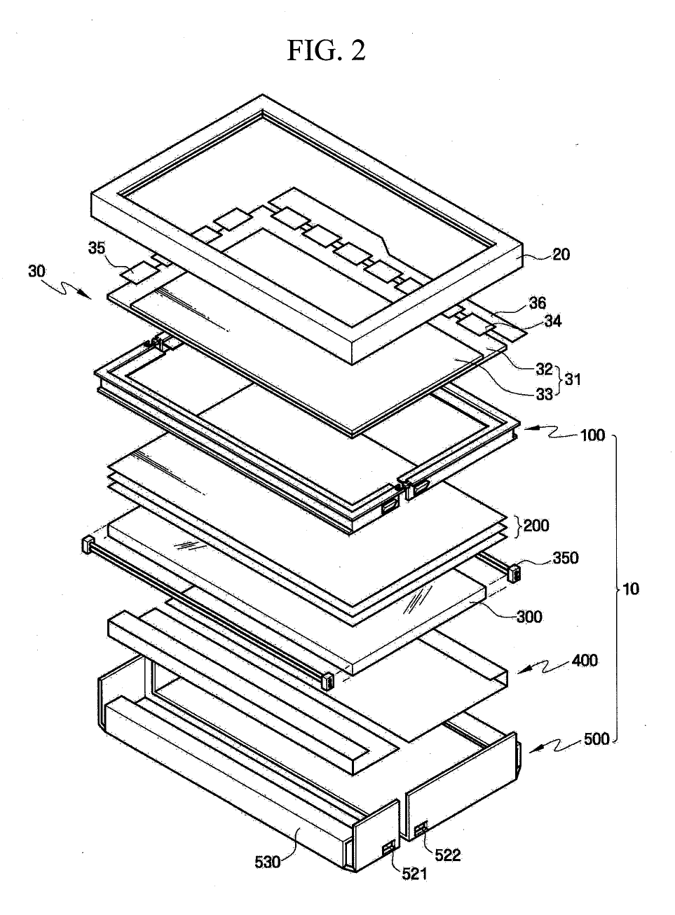

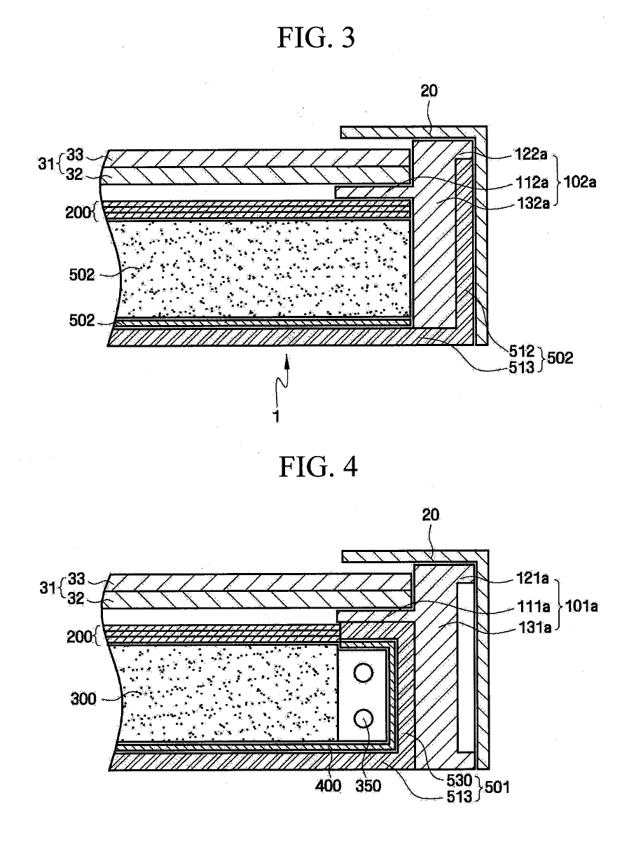

Hereinafter, a display apparatus according to a first exemplary embodiment of the present invention will be described with reference to FIGS. 1 through 4. FIG. 1 is a perspective view of a display apparatus 1 according to a first exemplary embodiment of the present invention. FIG. 2 is an exploded perspective view of the display apparatus 1 of FIG. 1. FIG. 3 is a cross-sectional view of the display apparatus 1 taken along a line III-III′ of FIG. 1. FIG. 4 is a cross-sectional view of the display apparatus 1 taken along a line VI-VI′ of FIG. 1.

Referring to FIGS. 1 and 2, the display apparatus 1 according to the first exemplary embodiment of the present invention includes a display panel assembly 30, an upper container 20, and a backlight assembly 10.

The display panel assembly 30 includes a display panel 31 which has a lower display substrate 32 and an upper display substrate 33, liquid crystals (not shown), gate chip film packages 35, data chip film packages 34, and a printed circuit board (PCB) 36.

The display panel 31 includes the lower display substrate 32 and the upper display substrate 33 which faces the lower display substrate 32. The lower display substrate 32 includes gate lines (not shown), data lines (not shown), a thin-film transistor (TFT) array, and pixel electrodes. The upper display substrate 33 includes color filters, black matrices and common electrodes. The color filters and the common electrodes may also be formed on the lower display substrate 32.

The gate chip film packages 35 are connected to the gate lines (not shown) formed on the lower display substrate 32, and the data chip film packages 34 are connected to the data lines (not shown) formed on the lower display substrate 32. Each of the gate chip film package 35 and the data chip film package 34 includes a tape automated bonding (TAB) tape which includes wiring patterns formed on a base film and a semiconductor chip bonded to the wiring patterns by a TAB technique. Examples of the chip film package according to the present invention includes, but are not limited to, a tape carrier package (TCP) and a chip on film (COF), which are, however, mere examples.

A plurality of driving parts are mounted on the PCB 36 to transmit gate-driving signals to the gate chip film packages 35 and data-driving signals to the data chip film packages 34.

The upper container 20 forms the exterior of the display apparatus 1 and has space in which the display panel assembly 30 is accommodated. An open window is formed in the center of the upper container 20 to expose the display panel 31. The upper container 20 is coupled to a lower container 500 with an intermediate frame 100 interposed therebetween.

The backlight assembly 10 includes the intermediate frame 100, an optical sheet 200, a light guide plate (LGP) 300, a light source 350, and a reflective sheet 400.

The light source 350 includes one or more light sources which emit light. The light sources may be line light sources, such as cold cathode fluorescent lamps (CCFLs), hot cathode fluorescent lamps (HCFLs) and external electrode fluorescent lamps (EEFLs), or point light sources such as light emitting diodes (LEDs). If the backlight assembly 10 is an edge-type backlight assembly as shown in FIG. 2, the light source 350 may be installed on one or more side surfaces of the LGP 300. That is, the light source 350 may be installed on a side surface of the LGP 300 or, when necessary, on both side surfaces of the LGP 300.

The LGP 300 guides light emitted from the light source 350 toward the display panel assembly 30. The LGP 300 is made of a transparent plastic material, such as acryl, and guides light emitted from the light sources toward the display panel 31 which is disposed above the LGP 300. Therefore, various patterns may be printed on a bottom surface of the LGP 300 in order to guide light, which is input into the LGP 300, toward the display panel 31.

The optical sheet 200 is disposed on the LGP 300 and diffuses and concentrates light from the LGP 300. The optical sheet 200 may include at least one of a diffusion sheet, a prism sheet and a protective sheet. Alternatively, the optical sheet 200 may be a single optical sheet having the functions of the diffusion sheet, the prism sheet and the protective sheet. That is, the optical sheet 200 may include a lower portion having a diffusion function, a prism pattern (not shown) formed on the lower portion, and a protective layer (not shown) formed on the prism pattern. In this container, since the single optical sheet 200 has the diffusion and prism functions, the number of elements included in the display apparatus 1 can be reduced. Consequently, the display apparatus 1 can become slimmer.

The intermediate frame 100 accommodates the optical sheet 200, the LGP 300, and the light source 350 and is firmly fixed to the lower container 50. An open window is formed in the center of the intermediate frame 100 to allow light that passed through the LGP 300 and the optical sheet 200 to also pass through the intermediate frame 100. Referring to FIGS. 3 through 5, the intermediate frame 100 is split into a first frame 101a and a second frame 102a such that a parting surface of the intermediate frame 100 is perpendicular to the display panel 31.

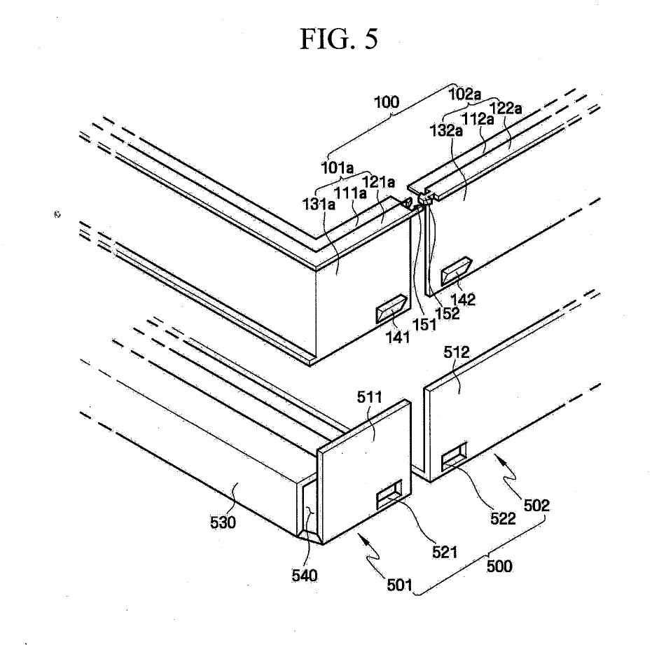

Referring to FIGS. 4 and 5, the first frame 101a includes first sidewalls 131a which are formed along rectangular edges of the first frame 101a, first flanges 111a which protrude respectively from the first sidewalls 131a toward the center of the first frame 101a, and first extension portions 121a which are formed at respective top ends of the first sidewalls 131a and contact the upper container 20.

Referring to FIGS. 3 and 5, the second frame 102a includes second sidewalls 132a which are formed along rectangular edges of the second frame 102a and coupled to the first sidewalls 131a, respectively, second flanges 112a which protrude respectively from the second sidewalls 132a toward the center of the second frame 102a, and second extension portions 122a which are formed at respective top ends of the second sidewalls 132a and contact the upper container 20.

The intermediate frame 100 may be formed by a molding process. Alternatively, the first and second frames 101a and 102a of the intermediate frame 100 may be formed separately by an injection-molding process.

The intermediate frame 100 is a rectangular frame having an aperture and is split into the first frame 101a and the second frame 102a. The first and second frames 101a and 102a are formed by cutting the rectangular intermediate frame 100 in a direction perpendicular to a surface of the display panel 31. That is, since the parting surface of the intermediate frame 100 is in a vertical direction of the display panel 31, the intermediate frame 100 is split into the first and second frames 101a and 102a in a horizontal direction of the display panel 31.

The first frame 101a and the second frame 102a may be coupled to each other by hooks or raised and depressed portions, which will be described in detail later.

Referring to FIGS. 2 through 4, the first frame 101a includes the first sidewalls 131a which form a rectangle, and the second frame 102a includes the second sidewalls 132a which form a rectangle. The first and second sidewalls 131a and 132a form four sidewalls of the intermediate frame 100. At least one sidewall of the intermediate frame 100 may be split into the first and second sidewalls 131a and 132a. The intermediate frame 100 may be rectangularly shaped, like “□” when viewed from the top, and each of the first and second frames 101a and 102a into which the intermediate frame 100 is split, may have the shape [symbol] when viewed from the top.

The first and second frames 101a and 102a include the first and second flanges 111a and 112a, respectively, on which the display panel 31 is placed. The first and second flanges 111a and 112a protrude respectively from the first and second sidewalls 131a and 132a toward the center of the intermediate frame 100. In addition, the first and second flanges 111a and 112a are disposed on the same plane to form a flat surface with the display panel 31, thereby allowing the display panel 31 to be securely positioned thereon. The LGP 300 and the optical sheet 200 are placed under the first and second flanges 111a and 112a.

The first and second frames 101a and 102a include the first and second extension portions 121a and 122a, respectively, which extend from respective ends of the first and second sidewalls 131a and 132a in a direction away from center of the intermediate frame 100. The first and second extension portions 121a and 122a may provide a coupling surface between the lower container 500 and the intermediate frame 100 and a coupling surface between the first and second frames 101a and 102a. The first and second extension portions 121a and 122a may extend higher than the first and second flanges 111a and 112a to form a coupling surface with the upper container 20 (see FIGS. 3 and 4). The first and second frames 101a and 102a may be coupled to each other by hooks or raised and depressed portions. Each of the first and second frames 101a and 102a may have a raised and depressed surface which is formed in a direction perpendicular or parallel to the surface of the display panel 31.

The lower container 500 is coupled to a lower portion of the intermediate frame 100. The lower container 500 is split into a first lower container 501 and a second lower container 502 along the parting surface of the intermediate frame 100. The first and second lower containers 501 and 502 are coupled to each other to enclose the LGP 300, the optical sheet 200 and the light source 350 in the space formed with the intermediate frame 100. The lower container 500 may be formed in a sheet-metal working process by using a metal plate.

The first and second lower containers 501 and 502 include first and second walls 511 and 512, respectively. The first and second walls 511 and 512 are formed by bending an end of a bottom surface 513 of the lower container 500. The first and second walls 511 and 512 may be coupled to the first and second sidewalls 131a and 132a of the first and second frames 101a and 102a, respectively.

A light source cover 530 is formed at an end of the lower container 500. That is, the light source cover 530 may be formed by bending an end of the lower container 500, and the light source 350 is inserted into the light source cover 530. In an edge-type display apparatus, the light source 350 may be disposed on a side of the LGP 300, and the light source cover 530 may be formed in the lower container 500 to surround the light source 350.

The light source cover 530 may be formed in at least one of the first and second lower containers 501 and 502 and may form a sidewall of the lower container 500. The light source cover 530 may be surrounded and thus be enclosed by one of the first flanges 111a and one of the first sidewalls 131a. That is, the light source cover 530 may be disposed inside one of the first sidewalls 131a and under one of the first flanges 111a. The light source covers 530 may be formed in the first and second lower containers 501 and 502, respectively, to face each other.

The first and second sidewalls 131a and 132a of the first and second frames 101a and 102a may be disposed inside the first and second walls 511 and 512 of the lower container 500, respectively. That is, some sidewalls of the intermediate frame 100 may be disposed inside the lower container 500 while the other sidewalls of the intermediate frame 100 may be disposed outside the lower container 500.

The reflective sheet 400 is installed under the LGP 300 and reflects light, which is emitted downward from the LGP 300, in an upward direction. The reflective sheet 400 is disposed under the LGP 300 and reflects light which has not been reflected by minute dot patterns formed on the bottom surface of the LGP 300 towards an exit surface of the LGP 300. Therefore, the reflective sheet 400 reduces the loss of light which is incident to the display panel 31 and, at the same time, improves the uniformity of light which passes through the exit surface of the LGP 300. The reflective sheet 400 may be inserted as a separate sheet. Alternatively, the reflective sheet 400 may be a reflective pattern formed by coating a highly reflective material on the lower container 500. The reflective sheet 400 may be split in the same manner as the lower container 500 and inserted into the lower container 500. That is, the reflective sheet 400 may be split into portions which are shaped like the first and second lower containers 501 and 502, respectively, and the portions of the reflective sheet 400 may be inserted into the first and second lower containers 501 and 502, respectively.

The reflective sheet 400 may extend into the light source cover 530 so as to efficiently reflect the light emitted from the light source 350. An end of the reflective sheet 400 inside the light source cover 530 may be bent such that it has a cross section in the shape [symbol] the cross section taken perpendicularly to the length of the light source cover 530. Thus, the end of the reflective sheet 400 may be shaped like the light source cover 530.

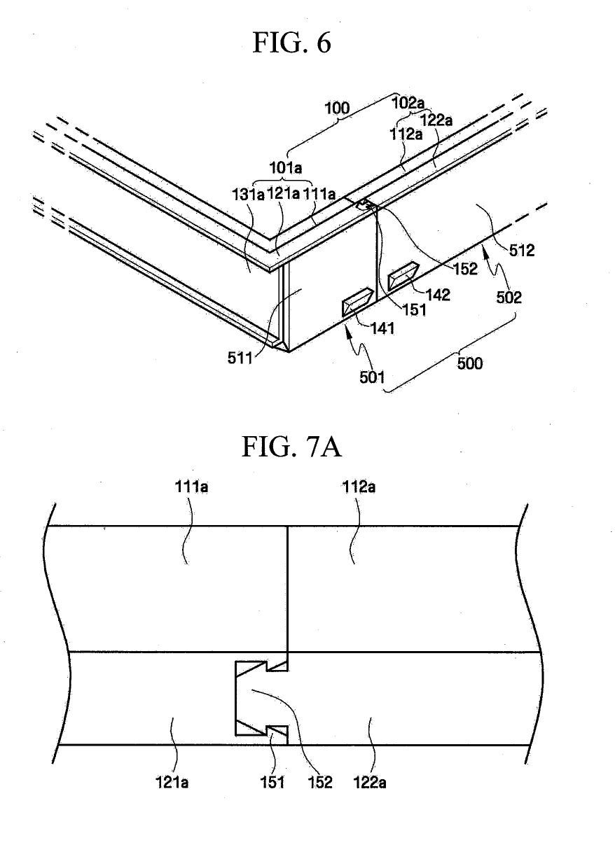

Hereinafter, the coupling relationship between the intermediate frame 100 and the lower container 500 will be described in detail with reference to FIGS. 5 and 6. FIG. 5 is a partial exploded perspective view of the intermediate frame 100 and the lower container 500 included in the display apparatus 1 of FIG. 1. FIG. 6 is a perspective view of the intermediate frame 100 and the lower container 500 of FIG. 5, which are coupled to each other.

The first frame 101a [In FIG. 6, first frame 101a is marked “101”—please correct the “101” in FIG. 6 and replace it with “101a”] and the second frame 102a may be hooked to each other. Specifically, the first and second frames 101a and 102a may include first and second coupling portions 151 and 152, respectively. The first and second coupling portions 151 and 152 may hook the first and second frames 101a and 102a to each other. The first and second coupling portions 151 and 152 may be formed at the first and second extension portions 121a and 122a, respectively. The first and second coupling portions 151 and 152 may be integrated with the first and second extension portions 121a and 122a, respectively, and may be formed on the same plane as the first and second extension portions 121a and 122a, respectively.

The intermediate frame 100 and the lower container 500 may be hooked to each other. Specifically, the first and second frames 101a and 102a may include first and second coupling protrusions 141 and 142, respectively. In addition, the first and second lower containers 501 and 502 may include first and second coupling grooves 521 and 522, as shown in FIG. 5, which are coupled to the first and second coupling protrusions 141 and 142, respectively.

In order to couple the intermediate frame 100 to the lower container 500, the first and second lower containers 501 and 502 are coupled to each other with the light source 350, the reflective sheet 400 and the LGP 300 interposed therebetween such that the first and second walls 511 and 512 are aligned with each other.

Then, the first flanges 111a, the first sidewalls 131a and the first extension portions 121a are coupled to the second flanges 112a, the second sidewalls 132a (as shown in FIG. 5) and the second extension portions 122a, respectively, thereby coupling the first and second frames 101a and 102a to each other. The first and second coupling portions 151 and 152 of the first and second extension portions 121a and 122a are hooked to each other, thereby fixing the first frame 101a to the second frame 102a.

Next, the intermediate frame 100 is coupled to the lower container 500. As shown in FIG. 6, some sidewalls of the intermediate frame 100 are disposed inside the lower container 500 while the other sidewalls of the intermediate frame 100 are disposed outside the lower container 500.

As shown in FIG. 5, the lower container 500 includes the bottom surface 513 (shown in FIG. 3 and FIG. 4) and the first and second walls 511 and 512 and the light source covers 530 which extend from the bottom surface 513 and form the sidewalls of the lower container 500. The light source covers 530 and the first walls 511 extend from the bottom surface 513, and openings 540 are formed between one of the light source covers 530 and the first walls 511. Part of the intermediate frame 100 may pass through the openings 540 such that some sidewalls of the intermediate frame 100 are disposed inside the lower container 500 while the other sidewalls of the intermediate frame 100 are disposed outside the lower container 500.

The intermediate frame 100 is not necessarily coupled to the lower container 500 after the first and second frames 101a and 102a are coupled to each other. For example, the first and second frames 101a and 102a may be separately coupled to the lower container 500.

The intermediate frame 100 and the lower container 500 may be disjoined from each other in the reverse order with respect to the order in which they were joined to each other. In order to prevent the lower container 500 from being deformed when the intermediate frame 100 is disjoined from the lower container 500, the first and second frames 101a and 102a may first be disjoined from each other. Then, the first and second frames 101a and 102a may be disjoined from the lower container 500 one by one. That is, if the first and second coupling portions 151 and 152 of the first and second frames 101a and 102a are disjoined from each other first, the first and second sidewalls 131a and 132a are elastically deformed. Thus, the first and second sidewalls 131a and 132a can be disjoined from the lower container 500 without deforming the first and second walls 511 and 512 of the lower container 500.

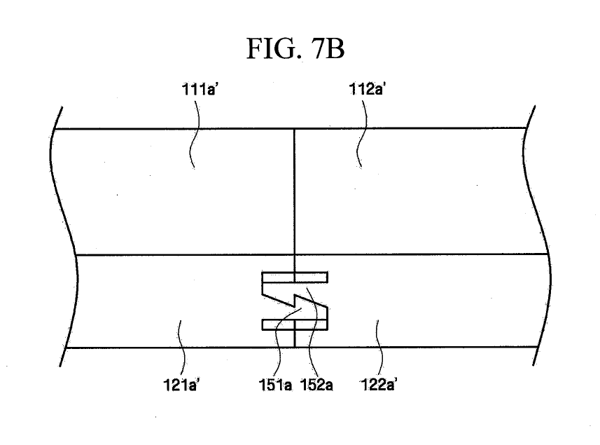

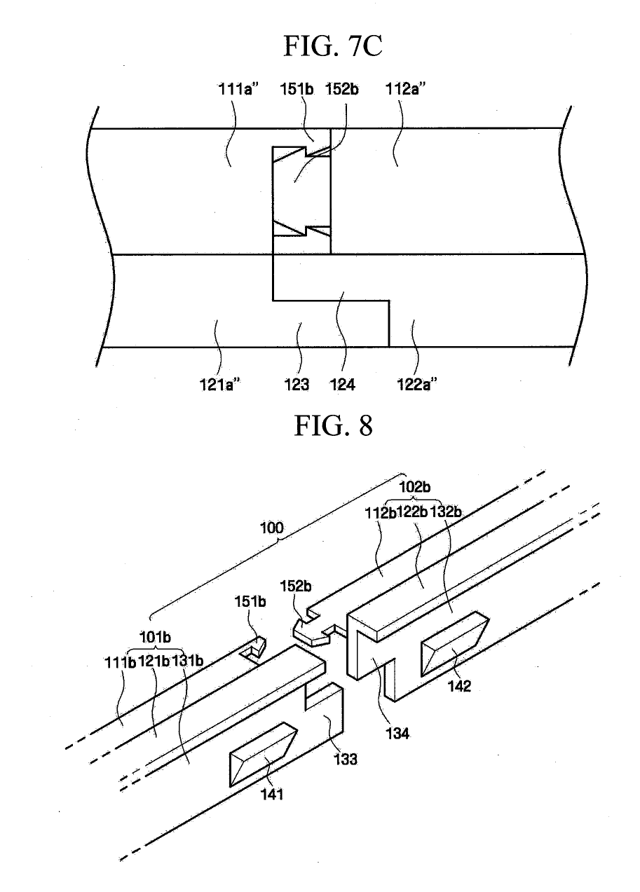

Coupling portions of the intermediate frame 100 will now be described in detail with reference to FIGS. 7A through 7C. FIG. 7A is a partial plan view of the intermediate frame 100 included in the display apparatus 1 of FIG. 1. FIG. 7B illustrates a modified version of the intermediate frame 100 of FIG. 7A. FIG. 7C illustrates another modified version of the intermediate frame 100 of FIG. 7A.

Referring to FIGS. 6, 7A and 7B, first and second coupling portions 151 or 151a and 152 or 152a may be formed at first and second extension portions 121a or 121a′ and 122a or 122a′, respectively. The first and second coupling portions 151 or 151a and 152 or 152a may be formed as raised and depressed couplers as shown in FIG. 7A or formed as hooking elements, which are symmetrical to each other, as shown in FIG. 7B.

Referring to FIGS. 6 and 7C, first and second coupling portions 151b and 152b may be formed in first and second flanges 111a, 111a′ or 111a″ and 112a, 112a′ or 112a″, respectively. Specifically, the first and second coupling portions 151b and 152b which couple the first and second frames 101a and 102a to each other may be formed in the first flanges 111a″ and 112a″, respectively. In addition, first and second raised and depressed portions 123 and 124 may be formed in first and second extension portions 121a″ and 122a″, respectively, in order to prevent respective coupling surfaces of the first and second frames 101a and 102a from being misaligned with each other.

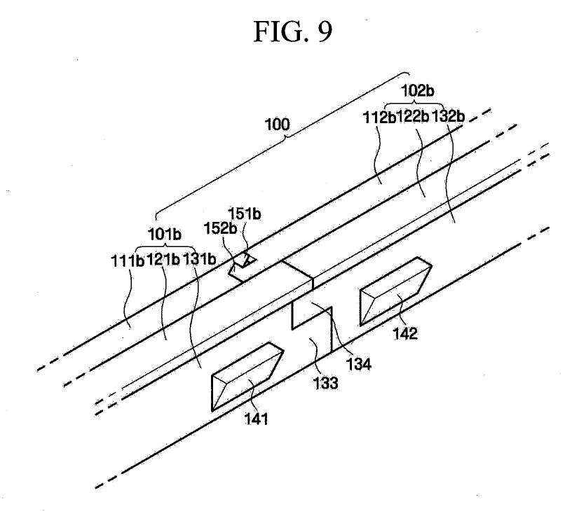

Hereinafter, a display apparatus according to a second exemplary embodiment of the present invention will be descried in detail with reference to FIGS. 8 and 9. FIG. 8 is a partial exploded perspective view of an intermediate frame 100 included in the display apparatus according to the second exemplary embodiment of the present invention. FIG. 9 is a perspective view of the intermediate frame 100 of FIG. 8 which has first and second frames 101b and 102b coupled to each other. Elements having the same functions as those illustrated in the drawings of the first exemplary embodiment are indicated by like reference numerals, and thus their description will be omitted.

In the display apparatus according to the second exemplary embodiment, first and second flanges 111b and 112b are coupled to each other by hooks, and first and second sidewalls 131b and 132b are coupled to each other by raised and depressed portions, thereby coupling the first frame 101b to the second frame 102b.

The first and second flanges 111b and 112b include first and second coupling portions 151b and 152b, respectively. As described above, the first and second coupling portions 151b and 152b may hook the first and second frames 101b and 102b to each other. The first and second coupling portions 151b and 152b may be integrated with the first and second flanges 111b and 112b, respectively.

The first and second flanges 111b and 112b are where a display panel 31 is placed. In order to protect the display panel 31, the first and second coupling portions 151b and 152b must be formed on the same plane as or under the first and second flanges 111b and 112b, respectively.

The first and second sidewalls 131b and 132b include first and second raised and depressed portions 133 and 134, respectively, in order to prevent the first and second sidewalls 131b and 132b from being misaligned with each other. The first and second frames 101b and 102b also include first and second coupling protrusions 141 and 142, and first and second extension portions 121b and 122b, as described above.

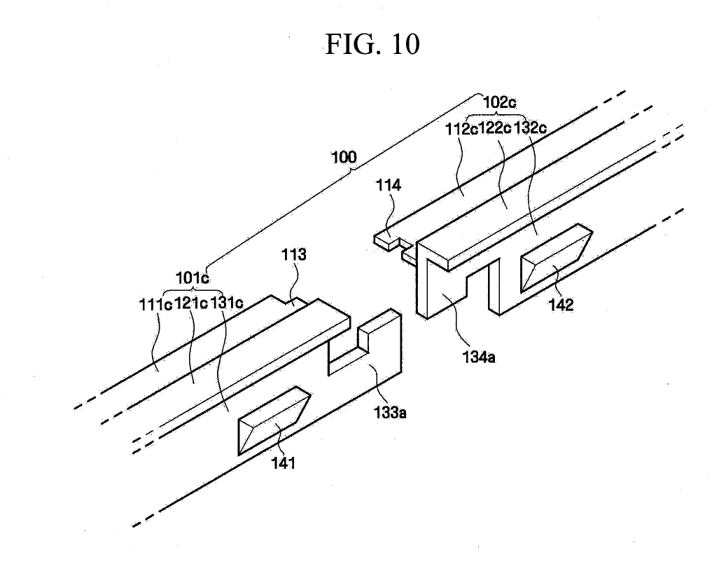

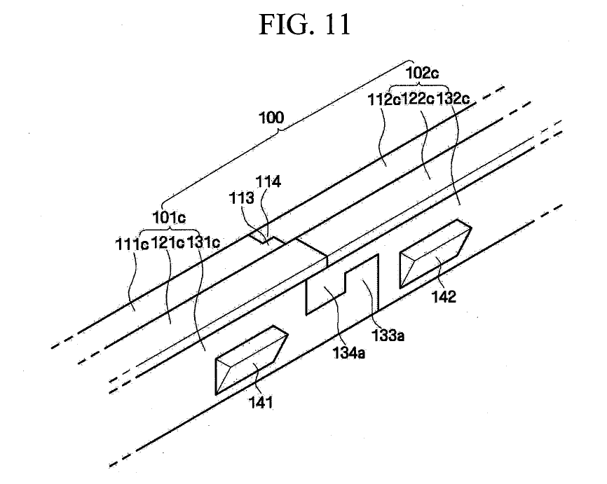

Hereinafter, a display apparatus according to a third exemplary embodiment of the present invention will be described with reference to FIGS. 10 and 11. FIG. 10 is a partial exploded perspective view of an intermediate frame 100 included in the display apparatus according to the third exemplary embodiment of the present invention. FIG. 11 is a perspective view of the intermediate frame 100 of FIG. 10 which has first and second frames 101c and 102c coupled to each other. Elements having the same functions as those illustrated in the drawings of the first exemplary embodiment are indicated by like reference numerals, and thus their description will be omitted.

In the display apparatus according to the third exemplary embodiment, first and second flanges 111c and 112c are coupled to each other by raised and depressed portions, and first and second sidewalls 131c and 132c are also coupled to each other by raised and depressed portions in order to couple the first frame 101c to the second frame 102c.

The first and second flanges 111c and 112c include first and second raised and depressed portions 113 and 114, respectively, and the first and second raised and depressed portions 113 and 114 engage each other. The first and second raised and depressed portions 113 and 114 may be integrated with the first and second flanges 111c and 112c, respectively.

The first and second flanges 111c and 112c are where a display panel 31 is placed. In order to protect the display panel 31, the first and second raised and depressed portions 113 and 114 must be formed on the same plane as or under the first and second flanges 111c and 112c, respectively.

The first and second raised and depressed portions 113 and 114 may engage each other to form a flat surface. Thus, the first and second raised and depressed portions 113 and 114 can prevent the first and second frames 101c and 102c from being misaligned with each other in a horizontal direction.

The first and second sidewalls 131c and 132c include third and fourth raised and depressed portions 133a and 134a, respectively, and the third and fourth raised and depressed portions 133a and 134a may engage each other. The third and fourth raised and depressed portions 133a and 134a may be integrated with the first and second sidewalls 131c and 132c to prevent the first and second frames 101c and 102c from being misaligned with each other in a vertical direction. Here, respective surfaces of the third and fourth raised and depressed portions 133a and 134a may have various shapes. That is, the respective surfaces of the third and fourth raised and depressed portions 133a and 134a may have any shape as long as they can engage each other to couple the first frame 101c to the second frame 102c. The first and second frames 101c and 102c also include first and second coupling protrusions 141 and 142 and first and second extension portions 121c and 122c, respectively, as described above.

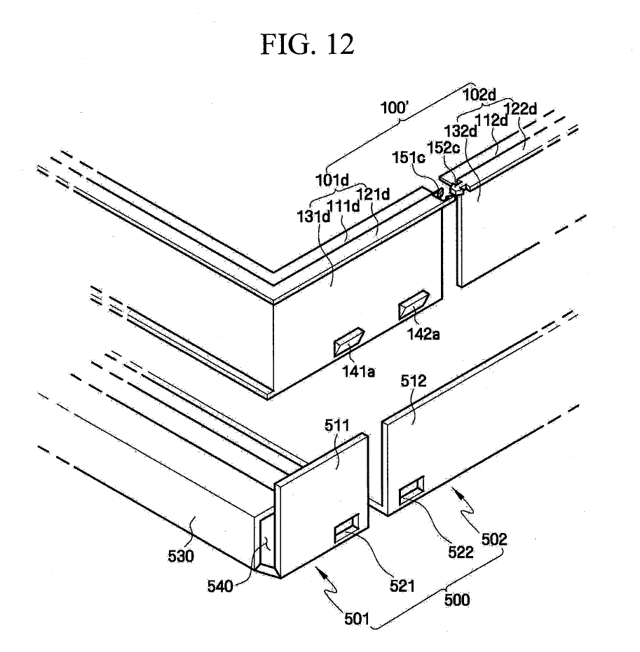

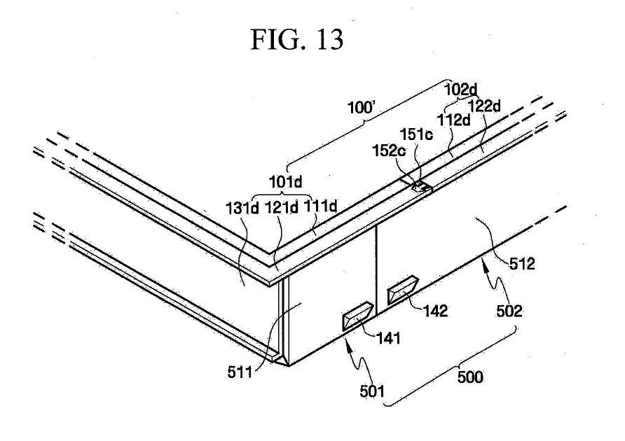

Hereinafter, a display apparatus according to a fourth exemplary embodiment of the present invention will be described with reference to FIGS. 12 and 13. FIG. 12 is a partial exploded perspective view of an intermediate frame 100′ included in the display apparatus according to the fourth exemplary embodiment of the present invention. FIG. 13 is a perspective view of the intermediate frame 100′ of FIG. 12 which has first and second frames 101d and 102d coupled to each other. Elements having the same functions as those illustrated in the drawings of the first exemplary embodiment are indicated by like reference numerals, and thus their description will be omitted.

In the display apparatus according to the fourth exemplary embodiment, a coupling surface between the first and second frames 101d and 102d may be misaligned with a coupling surface between first and second lower containers 501 and 502. That is, respective lengths of the first and second sidewalls 131d and 132d of the first frame 101d may be different from those of first and second walls 511 and 512 of the first lower container 501, respectively.

If the coupling surface between the first and second frames 101d and 102d is misaligned with that between the first and second lower containers 501 and 502, a location where the first and second frames 101d and 102d are separated from each other may be different from a location where the first and second lower containers 501 and 502 are separated from each other. Therefore, the first and second frames 101d and 102d can be coupled to each other in a more stable manner.

If the coupling surface between the first and second frames 101d and 102d is misaligned with that between the first and second lower containers 501 and 502 as described above, first and second coupling protrusions 141a and 142a may all be formed on the first sidewalls 131d.

On the other hand, first and second coupling grooves 521 and 522 corresponding respectively to the first and second coupling protrusions 141a and 142a may be formed in the first and second walls 511 and 512, respectively.

In order to disassemble a lower container 500, the first and second frames 101d and 102d may first be disjoined from each other. Then, the first and second coupling protrusions 141a and 142a of the first sidewalls 131d may be disjoined from the first and second coupling grooves 521 and 522 of the first lower container 501. After the first and second frames 101d and 102d are disjoined from each other as described above, the first and second lower containers 501 and 502 may be disjoined from each other. First and second frames 101d and 102d also include first and second flanges 111d and 112d, first and second extension portions 121d and 122d, and first and second coupling portions 151c and 152c, as described above.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A display apparatus comprising:
a display panel which displays images;
an intermediate frame on which the display panel is placed, the intermediate frame being split into two or more frames; and
a container which is split into two or more containers, is coupled to the intermediate frame, and comprises a light source cover integrally formed on at least a side thereof,
wherein a light source is inserted into the light source cover.

2. The apparatus of claim 1, wherein the intermediate frame and the container are coupled to each other by hooks.

3. The apparatus of claim 1, wherein the intermediate frame is split into first and second frames, and the first and second frames are coupled to each other by hooks or raised and depressed portions.

4. The apparatus of claim 3, wherein the first frame comprises first sidewalls, first flanges which protrude respectively from the first sidewalls toward the center of the first frame, and first extension portions which are formed at respective top ends of the first sidewalls, and
the second frame comprises second sidewalls, second flanges which protrude respectively from the second sidewalls toward the center of the second frame, and second extension portions which are formed at respective top ends of the second sidewalls,
wherein at least one of a pair of the first and second sidewalls, a pair of the first and second flanges, and a pair of the first and second extension portions are coupled to each other by hooks or raised and depressed portions.

5. The apparatus of claim 4, wherein the first and second flanges are coupled to each other to form a flat surface.

6. The apparatus of claim 1, wherein the intermediate frame comprises first and second sidewalls which form a parting surface, and the container comprises first and second walls which form a parting surface, wherein the first and second sidewalls are placed inside and coupled to the first and second walls, respectively.

7. The apparatus of claim 1, wherein the light source cover is formed by bending an end of the container.

8. The apparatus of claim 7, wherein the light source cover is placed inside the intermediate frame.

9. The apparatus of claim 1, further comprising a reflective sheet positioned between the light source and the container.

10. The apparatus of claim 9, wherein the reflective sheet is bent along the shape of an inner surface of the light source cover.

11. The apparatus of claim 1, wherein the parting surface of the intermediate frame is aligned with a parting surface of the container.

12. The apparatus of claim 1, wherein the parting surface of the intermediate frame is misaligned with a parting surface of the container.

13. The apparatus of claim 1, wherein the parting surface of at least one of the intermediate frame and the container is perpendicular to the display panel.

14. A display apparatus comprising:
a display panel which displays images;
a first frame which comprises first sidewalls, first flanges protruding respectively from the first sidewalls toward the center of the first frame and having the display panel placed thereon, and first extension portions extending from respective top ends of the first sidewalls;
a second frame which comprises second sidewalls, second flanges and second extension portions coupled to the first sidewalls, the first flanges and the first extension portions, respectively, and which is coupled to the first frame; and
a container which is split into two or more containers and coupled to the first and second frames.

15. The apparatus of claim 14, wherein the first and second frames are coupled to each other by hooks or raised and depressed portions.

16. The apparatus of claim 15, wherein each of the first and second frames has a raised and depressed surface formed in a direction perpendicular or parallel to a surface of the display panel.

17. The apparatus of claim 15, wherein at least one of a pair of the first and second sidewalls, a pair of the first and second flanges, and a pair of the first and second extension portions are coupled to each other by hooks or raised and depressed portions.

18. The apparatus of claim 14, wherein the first and second frames are coupled to the container by hooks.

19. The apparatus of claim 14, wherein the container comprises a light source cover formed on at least a side thereof, wherein a light source is inserted into the light source cover.
